(19) United States
(12) Patent Application Publication
(10) Pub. No.: US 2026/0002803 A1
(43) Pub. Date: Jan. 1, 2026

(54) METHOD FOR OPERATING A MAGNETIC-INDUCTIVE FLOWMETER AND MAGNETIC-INDUCTIVE FLOWMETER

(71) Applicant: KROHNE AG, Basel (CH)

(72) Inventors: Guus REIJNDERS, Stampersgat (NL); Arthur DEN HAAN, Leiden (NL); Robin STEVENHAGEN, Maassluis (NL)

(73) Assignee: KROHNE AG, Basel (CH)

(21) Appl. No.: 19/253,382

(22) Filed: Jun. 27, 2025

(30) Foreign Application Priority Data
Jun. 28, 2024 (DE) 10 2024 118 322.5

(51) Int. Cl. G01F 1/60; G01F 1/58; G01F 25/10

(52) U.S. Cl. CPC G01F 1/60; G01F 1/584; G01F 25/10

(57) ABSTRACT

A method for operating a magnetic-inductive flowmeter that comprises at least one measuring tube for conducting a flowing medium through the flowmeter. At least one magnetic field generator generates a magnetic field passing through the measuring tube in a measuring region. At least one pair of measuring electrodes in the measuring region of the measuring tube tap an electrical voltage induced in the medium in the measuring tube, and at least one control and evaluation unit which, in a flow measurement mode, determines a flow measurement value from the measured induced electrical voltage. In a conductivity measuring mode, a measuring current is fed into the medium in the measuring tube via circuit electrodes. The control and evaluation unit determines the electrical conductivity of the medium in the measuring tube on the basis of a measuring electrode voltage recorded by at least one of the measuring electrodes.

This nonprovisional application claims priority under 35 U.S.C. § 119(a) to German Patent Application No. 10 2024 118 322.5, which was filed in Germany on Jun. 28, 2024, and which is herein incorporated by reference.

### BACKGROUND OF THE INVENTION

### Field of the Invention

The invention relates to a method for operating a magnetic-inductive flowmeter, wherein the magnetic-inductive flowmeter comprises at least one measuring tube with an inflow region, an outflow region and with a measuring region located between the inflow region and the outflow region for conducting a flowing medium through the flowmeter, at least one magnetic field generating device for generating a magnetic field passing through the measuring tube in the measuring region perpendicular to the direction of flow of the medium, at least one pair of measuring electrodes in the measuring region of the measuring tube for tapping an electrical voltage induced in the medium in the measuring tube, and at least one control and evaluation unit which determines a flow measurement value from the measured induced electrical voltage in a flow measurement mode. In addition, the invention also relates to such a magnetic-inductive flowmeter.

### Description of the Background Art

The aforementioned flowmeters, which are based on the magnetic-inductive measuring principle, have been known for decades. Consequently, methods for operating such flowmeters as described above have also been known for a long time. The magnetic-inductive measuring principle is based on the action of force on charge carriers that move perpendicular to a magnetic field or that have a component of movement perpendicular to the magnetic field in question (Lorentz force). In order to be able to perform a flow measurement based on this principle in “normal operation” of the flowmeter, i.e. in flow measurement mode, the medium in the measuring tube must have a minimum electrical conductivity. The faster the medium moves through the measuring tube and thus also through the magnetic field generated by the magnetic field generating device, the stronger the separation of charge carriers in the flowing medium of the corresponding measuring tube section, and the stronger the electric field caused by the charge separation, which forms between the electrodes of the measuring tube and can be picked up as an induced electric voltage between the measuring electrodes. The induced voltage between the measuring electrodes develops in proportion to the flow velocity, at least during the period in which the magnetic field is constant.

It is known to use magnetic-inductive flowmeters not only to determine their primary measured variable, i.e. a flow measurement value in flow measurement mode, but also to determine secondary measured variables, such as a measured value of the electrical conductivity (in 1/ohmmeter) of the medium flowing through the flowmeter. The electrical conductivity is a material parameter of the medium, its reciprocal value is the specific electrical resistance of the medium (in ohmmeter). Information about the conductivity of the medium can be of interest for various reasons, firstly because a certain minimum conductivity of the medium must be present in order to capture flow information, and secondly because the medium conductivity can also be a relevant process variable, which is therefore important to capture. DE 10 2014 007 426 A1, which corresponds to US 2015/0000421, which is incorporated herein by reference, and which describes a method for determining the electrical conductivity of the medium, in which a signal for determining the conductivity of the medium is fed into the medium via the measuring electrodes of the magnetic-inductive flowmeter.

### SUMMARY OF THE INVENTION

It is therefore an object of the present invention is to provide an improved method for determining the electrical conductivity of a medium using a magnetic-inductive flowmeter.

The object is initially achieved by arranging a first current circuit electrode and a second current circuit electrode in the region of the measuring tube in contact with the medium, at least when the measuring tube is completely filled, i.e. filled to a predetermined level, with medium, and by connecting the current circuit electrodes to a current source outside the measuring tube and applying a measuring current to them in a conductivity measurement mode, wherein the current circuit electrodes are arranged such that the current circuit closes via a medium current path at least when the measuring tube is completely filled with medium, wherein the medium current path passes the flow cross-section of the measuring tube in which the measuring electrodes are located, so that an electrical voltage drop occurs between the current circuit electrodes in the medium. In conductivity measurement mode, at least one measuring electrode voltage is captured with at least one of the measuring electrodes and the control and evaluation unit determines the electrical conductivity of the medium in the measuring tube from the captured measuring electrode voltage.

In the method according to an example of the invention, it has been found to be advantageous that the measuring electrodes, which are used in flow measurement mode to capture the electrical voltage induced in the medium, are not used in conductivity measurement mode to feed an electrical measuring signal suitable for conductivity measurement into the medium; the circuit electrodes, which are different from the measuring electrodes, are provided for this purpose. One reason for this is that a current flow via the measuring electrodes can result in undesirable electrochemical effects on the measuring electrodes, which can have a detrimental effect on the flow measurement. Another advantage of the solution according to the invention is the avoidance of a complex circuitry solution in order to reconcile a sensitive voltage measurement on one hand and the introduction of a robust measuring signal on the other hand via the measuring electrodes. The method according to the invention is basically not concerned with the primary measurement mode of the magnetic-inductive flowmeter, i.e. the flow measurement mode, but with the secondary measurement mode, i.e. the conductivity measurement mode, even if this is not always emphasized.

The solution according to the invention, in which a measuring current is applied to the medium via circuit electrodes—which are different from the measuring electrodes—in conductivity measuring mode, avoids the problem points mentioned and also enables the measuring electrodes, which are in principle associated with the possibility of highly sensitive voltage measurement, to be used to precisely capture the relevant measured variable, namely a measuring electrode voltage caused by the impressed measuring current in the medium, which is ultimately used to determine the electrical conductivity of the medium.

The measuring tube may extend over the entire length of the flowmeter, from the inflow region to the outflow region, including any terminals for mounting the flowmeter, insofar as these also carry the medium. The magnetic-inductive flowmeter is usually installed in such a way that the measuring electrodes lie on a horizontal connecting line and the magnetic field generating device generates a vertical magnetic field perpendicular to this, i.e. in the direction of the earth's gravitational field. In normal measuring mode, the medium completely fills and flows through the flowmeter. The determination of the flow measurement value is also based on this assumption.

With a completely medium-filled measuring tube, the current circuit electrodes can be arranged practically anywhere in the area of the measuring tube, they only need to be in contact with the medium so that the measuring current fed into the medium via the current circuit electrodes can form a closed circuit via its medium current path during conductivity measurement operation. The circuit electrodes must be arranged in the area of the measuring tube in such a way that the measuring current path passes through the area of the measuring electrodes so that the measuring current has a measurement-based detectable influence on the measuring electrodes and so that the electrical conductivity of the medium in the measuring tube can be determined at all.

If a constant measuring current is impressed into the medium via the circuit electrodes, a voltage of varying magnitude should be applied by the current source depending on the conductivity of the medium. The varying voltage can then be detected via the measuring electrodes and the electrical conductivity of the medium can then be deduced from the voltage to be set depending on the electrical conductivity of the medium. Basically, it is therefore a matter of measuring an electrical resistance that allows conclusions to be drawn about the electrical conductivity of the medium.

In an advantageous further development of the method, it is provided that the first current circuit electrode can be placed at a feed potential by the current source and the second current circuit electrode is placed at a reference potential, wherein the reference potential is the electrical reference potential to which the measuring electrode voltages are also measured. Advantageously, the reference potential is the electrical ground of the measuring circuit of the flowmeter.

The current source can generate an alternating current with a constant amplitude as the measuring current, in particular wherein the quantity of interest of the measuring electrode voltage in conductivity measurement mode is then the amplitude of the measuring electrode voltage. The use of an alternating current has the advantage that electrochemical effects on the electrodes, in this case the current circuit electrodes, which may be associated with a direct current or a direct voltage, are avoided. The electronic measuring system, which evaluates the measuring electrode voltage, is also set up to capture alternating voltages anyway, as the polarity of the electrical voltage induced in the medium also changes its sign due to the magnetic field of the magnetic field generating device, which usually changes its polarity. An alternative variation of the method is that the current source generates a direct current with a constant level, wherein the quantity of interest of the measuring electrode voltage in conductivity measurement mode is then the level of the measuring electrode voltage.

The flow measurement mode can be suspended during the conductivity measurement mode, in particular the magnetic field generating device is not energized, so that no magnetic field is generated during the conductivity measurement and therefore no voltage is induced in the flowing medium. This reliably prevents mutual interference between the different operating modes.

In an example of the method, the conductivity measurement mode can be performed at the same time as the flow measurement mode, i.e. also while the magnetic field generating device is energized. Usually, the magnetic field generating device can be energized at a determined frequency in different directions, resulting in a magnetic field whose polarity changes with the switching frequency of the magnetic field generating device. The magnetic field strength cannot change abruptly, as the current through the magnetic field generating device, which naturally has a certain inductance, can only change continuously. When switching the direction of current flow, the magnetic field decreases in one direction, becomes zero and builds up again in the other direction until it becomes stationary after this transient phase. While the magnetic field is stationary, the measuring electrodes capture a number of values for the electrical voltage induced in the medium, from which the flow measurement value of interest is calculated (flow measurement mode). It has proven to be advantageous if the conductivity measurement is performed either directly at the beginning of the changeover of the current flow direction, i.e. at the beginning of the transient phase of the magnetic field changeover, in which no measured values for the flow are captured anyway, or at the very end of the stationary phase of the magnetic field (and thus shortly before the changeover of the current flow direction), so that only a few measured values are affected that are relevant for the flow determination, i.e. only a few values for the flow measurement are omitted during the conductivity measurement mode.

In another advantageous design of the method, the relationship between the measuring electrode voltage captured in conductivity measurement mode and the electrical conductivity of the medium in the measuring tube can be established by calibrating the flowmeter with several media of different electrical conductivity. This is a pragmatic and uncomplicated approach with which good results can be achieved. It is also possible to try to establish the desired relationship analytically by integrating the material equation, which expresses the relationship between the electrical current density and the electrical field strength by means of the electrical conductivity of the medium, over the spatial area of the measuring tube, but this can generally only be solved numerically due to the measuring tube geometries alone. As a result, calibration with media of known electrical conductivity is considerably simpler and ultimately also more reliable.

In connection with the aforementioned calibration, it is further provided that a linear relationship between the measuring electrode voltage and the reciprocal value of the electrical conductivity of the medium in the measuring tube can be selected as a mathematical approximation of the relationship between the measuring electrode voltage captured in conductivity measurement mode and the electrical conductivity of the medium (i.e. the specific electrical resistance of the medium). In particular, several pairs of calibration values of the measuring electrode voltage and the corresponding reciprocal value of the conductivity of the medium are used to create a compensation curve, in particular a compensation line, and the compensation curve is used to determine the electrical conductivity of the medium as a function of the captured measuring electrode voltage in conductivity measurement mode.

A further improvement of the method is characterized in that the measurement current emitted by the current source can be measured in conductivity measurement mode. If the measured measuring current deviates from a target measuring current specified for the current source or if the current falls below a specified minimum current, the conductivity measurement or the conductivity measurement mode is recognized as faulty. The error detection is based on the idea that even with poorly conductive media, a minimum current should be able to be impressed into the medium. In particular, the detected error status is signaled to the outside, for example shown on a display or transmitted as an error message via a signal interface to the outside of the flowmeter.

A further improvement of the method with regard to a measuring device diagnosis is characterized in that the supply voltage at the first current circuit electrode can be measured in conductivity measurement mode. If the measured supply voltage is larger than a specified maximum value for the supply voltage, the conductivity measurement is recognized as faulty. Here too, the detected error status can be signaled to the outside, in particular it is shown on a display or transmitted as an error message via a signal interface to the outside of the flowmeter. Such a fault can be caused by an interrupted conductivity circuit, for example by a dry current circuit electrode.

Another further development of the method provides that the measuring current can be provided with a characteristic time curve and it is checked whether the captured measuring electrode voltage has a corresponding characteristic time curve in conductivity measurement mode. If the time characteristics of the measuring current and measuring electrode voltage deviate, the conductivity measurement is detected as faulty, wherein the detected error status is signaled to the outside. A characteristic time characteristic can be, for example, a sinusoidal oscillation with a constant or time-varying frequency, a sawtooth curve or a sequence of square-wave signals. Many other characteristic time courses are conceivable, but it is certainly an advantage if the selected time course can be identified quite easily.

Another further development of the method is characterized in that in conductivity measurement mode, two measuring electrode voltages can be captured with the two measuring electrodes and the two measuring electrode voltages are compared with each other. Here too, if the two measuring electrode voltages deviate beyond a deviation threshold, the conductivity measurement is detected as faulty, and in particular the detected error status is signaled to the outside. In general, a detected error status is preferably shown on a display or transmitted to the outside of the flowmeter as an error message via a signal interface.

The methods described may all be implemented in magnetic-inductive flowmeters of the type mentioned at the beginning. In order to be able to perform the method according to the invention, a first current circuit electrode and a second current circuit electrode can be arranged in the corresponding flowmeters according to the invention in the region of the measuring tube in contact with the medium, at least when the measuring tube is completely filled with medium, wherein the current circuit electrodes are connected to a current source outside the measuring tube and the current source applies a measuring current to the current circuit electrodes in a conductivity measuring mode.

As explained, it is necessary for the current circuit electrodes to be arranged in such a way that a current circuit is closed via a medium flow path, at least when the measuring tube is completely filled with medium, wherein the medium flow path passes through the flow cross-section of the measuring tube in which the measuring electrodes are located. In all magnetic-inductive flowmeters, the control and evaluation unit is designed in such a way that it performs the method for implementing the conductivity measurement mode in the conductivity measurement mode.

Magnetic-inductive flowmeters according to the invention can be designed in different ways. In an advantageous design, it is provided that at least one of the circuit electrodes is designed as a conductive flange at the end of the measuring tube (with medium contact).

In this context, an advantageous further development of the magnetic-inductive flowmeter is characterized in that both circuit electrodes can be designed as a conductive flange at the end of the measuring tube, wherein the first or the second circuit electrode can be arranged as one flange in the inflow region and wherein the second or the first circuit electrode can be arranged as the other flange in the outflow region of the measuring tube.

A magnetic-inductive flowmeter can also be characterized in that one of the circuit electrodes can be designed both as a conductive flange in the inflow region and as a conductive flange in the outflow region of the measuring tube.

In the examples in which a circuit electrode is designed as a flange or as a connection piece of the magnetic-inductive flowmeter, it is advisable to place this circuit electrode on the reference potential, ideally on the electrical ground of the flowmeter.

In another advantageous design of the magnetic-inductive flowmeter, one of the circuit electrodes in the area of the measuring tube can be arranged axially offset to a measuring electrode plane in which the measuring electrodes are arranged and which runs perpendicular to the axial extension of the measuring tube. Preferably, this current circuit electrode is arranged between the inflow region and the outflow region. It could, for example, be embedded in the wall of the measuring tube, where it must be electrically insulated accordingly. In a further design, both circuit electrodes in the area of the measuring tube are arranged axially offset to the measuring electrode plane and between the inflow region and the outflow region.

In an example, one of the current circuit electrodes can be arranged in the measuring electrode plane; both current circuit electrodes can also be arranged in the measuring electrode plane. This variation has manufacturing advantages, as only a limited area of the measuring tube has to be processed to implement the measuring electrodes and the current circuit electrodes (especially if these lie on a circumferential line of the measuring tube), but it has been found that better results can be achieved with regard to determining the electrical conductivity of the medium if the current circuit electrodes are arranged axially, i.e. offset from the measuring electrodes in the direction of flow of the medium, which therefore corresponds to the examples described above.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows schematically a method for operating a magnetic-inductive flowmeter and a corresponding magnetic-inductive flowmeter in flow measurement mode, as known from the prior art,

FIGS. 2A and 2B show schematically a method for operating a magnetic-inductive flowmeter and a corresponding magnetic-inductive flowmeter in a novel conductivity measurement mode,

FIGS. 3A and 3B show schematically calibration value pairs and compensation curves for the purpose of establishing a correlation between the conductivity of the medium and a measuring electrode voltage,

FIG. 4 shows schematically shows the previously shown method for operating a magnetic-inductive flowmeter and the corresponding magnetic-inductive flowmeter with additional measurement of a measuring current emitted by a current source and an input voltage at a current circuit electrode, and

FIGS. 5A to 5D show schematically different implementations of current circuit electrodes in a magnetic-inductive flowmeter.

### DETAILED DESCRIPTION

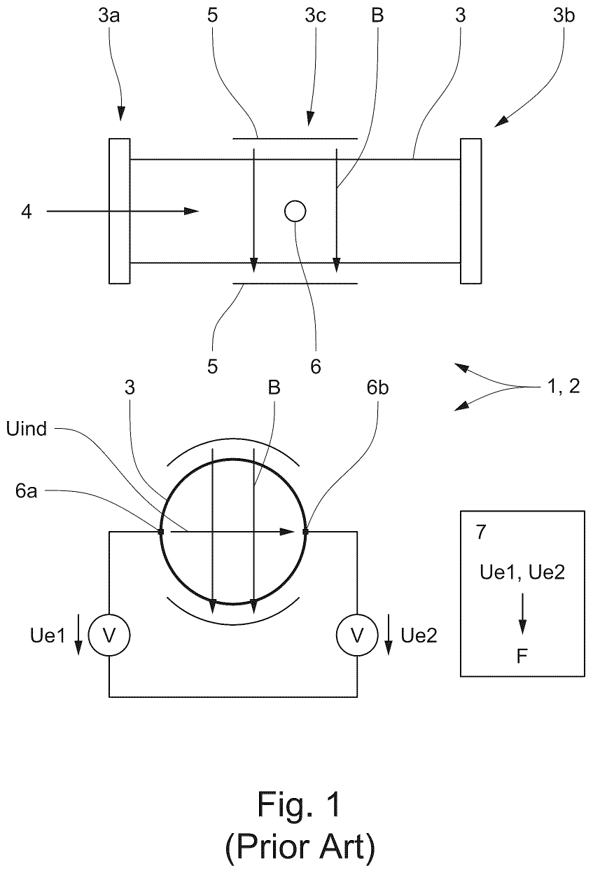

FIG. 1 shows a method 1 for operating a magnetic-inductive flowmeter 2 and a magnetic-inductive flowmeter 2 that performs this method 1, as known from the prior art. The “normal operation” of a magnetic-inductive flowmeter 2 is shown, which involves flow measurement.

The magnetic-inductive flowmeter 2 has a measuring tube 3 with an inflow region 3a, an outflow region 3b and a measuring region 3c located between the inflow region 3a and the outflow region 3b for performing a flowing medium 4 through the flowmeter 2. The measuring tube 3 may therefore be understood to be the entire area of the flowmeter 2 used to guide the medium flow, including any connecting parts, such as the flanges indicated here in the inflow region 3a and in the outflow region 3b.

In flow measurement mode, a magnetic field generating device 5 generates a magnetic field B that passes through the measuring tube 3 in the measuring region 3c perpendicular to the direction of flow of the medium 4. An electrical voltage Uind is induced in the medium 4, which must have a minimum electrical conductivity for the measuring principle to work, due to the Lorentz force exerted on moving charge carriers in the magnetic field B and the resulting charge separation. The induced electrical voltage Uind is proportional to the average flow velocity of the medium 4 in the measuring region 3c of the measuring tube 3, provided that the magnetic field strength B remains constant.

A pair of measuring electrodes 6a, 6b is arranged in the measuring region 3c of the measuring tube 3 for tapping the electrical voltage Uind induced in the medium 4 in the measuring tube 3. The connecting line between the two measuring electrodes 6a, 6b runs perpendicular to the direction of flow of the medium as well as perpendicular to the field lines of the magnetic field B in order to achieve a maximum measuring effect. The measuring electrodes 6a, 6b are electrically insulated from the wall of the measuring tube 3 and embedded in the wall of the measuring tube 3. In flow measurement mode, a control and evaluation unit 7 determines a flow measurement value F from the measured induced electrical voltage Uind. The illustration in FIG. 1 (as well as in the following figures) is actually very schematic. For example, it is not shown in detail how the measured values of the electrode voltages Ue1, Ue2 reach the control and evaluation unit 7. It is also not explicitly shown that the electrical voltage Uind induced in the medium 4 results from the difference between the two measuring electrode voltages Ue1, Ue2, but this is not important in detail or is known to the skilled person anyway.

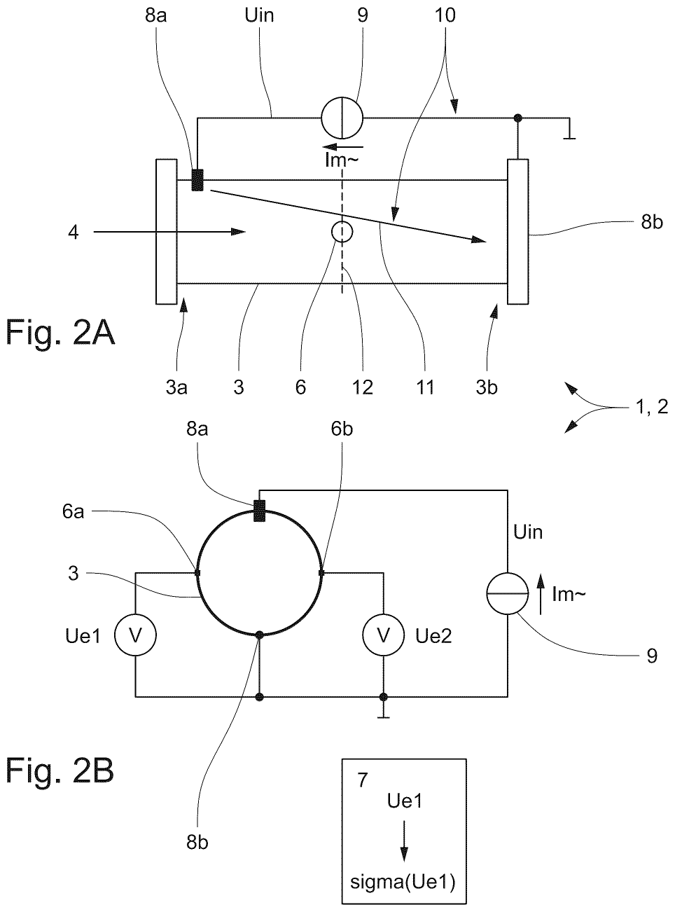

In the following FIGS. 2 to 5, various aspects of a method 1 for operating a magnetic-inductive flowmeter 2 and a corresponding magnetic-inductive flowmeter 2 are shown. However, the focus is not on flow measurement, but on determining the conductivity sigma of the medium 4 flowing through the magnetic-inductive flowmeter 2, so essentially the focus is on a conductivity measurement mode that is different from the flow measurement mode.

The examples in FIGS. 2 to 5 have in common that, for the sake of clarity, the magnetic field generating device is not shown. Another common feature of the examples is that a first circuit electrode 8a and a second circuit electrode 8b are arranged in the area of the measuring tube 3 in contact with the medium 4, at least when the measuring tube 3 is completely filled with medium. The circuit electrodes 8a, 8b are connected to a current source 9 outside the measuring tube 3. In conductivity measurement mode, a measuring current Im is therefore applied to the circuit electrodes 8a, 8b, wherein the circuit electrodes 8a, 8b are arranged such that a conductivity circuit 10 closes via a medium current path 11 in the medium 4 at least when the measuring tube 3 is completely filled with medium.

In FIG. 2A, the medium current path 11 runs from the first circuit electrode 8a, which is electrically insulated and embedded in the measuring tube 3, to the second circuit electrode 8b designed as a flange (from top left to right), wherein the flange is also electrically insulated from the adjacent area of the measuring tube 3. The positions of the circuit electrodes 8a, 8b are selected such that the medium flow path 11 passes the flow cross-section 12 of the measuring tube 3 in which the measuring electrodes 6a, 6b are located, so that an electrical voltage drop occurs between the circuit electrodes 8a, 8b in the medium and this electrical voltage can be detected in the medium 4 by the measuring electrodes 6a, 6b. The circuit electrodes 8a, 8b are arranged in such a way that the medium current path 11 has an axial extension in its course, i.e. in the direction of flow of the medium, which has proven to be advantageous for determining the electrical conductivity sigma of the medium 4.

In an example, which can be easily explained using FIG. 2A, both flanges, i.e. the inlet and outlet flanges of the measuring tube 3, are designed as a second circuit electrode 8b and are therefore connected to the electrical device ground. The medium flow path 11 is then divided into two parts, it runs on the one hand as shown in FIG. 2A, but on the other hand also from the first circuit electrode 8a to the left-side flange.

FIG. 2A does not show the measurement-based capture of the measuring electrode voltages Ue1, Ue2, but this is shown schematically in FIG. 2B. In conductivity measurement mode, at least one measuring electrode voltage Ue1, Ue2 is captured by at least one of the measuring electrodes 6a, 6b. The control and evaluation unit 7 determines the electrical conductivity sigma of the medium 4 in the measuring tube 3 from the captured measuring electrode voltage Ue1, Ue2. It is sufficient to capture one of the measuring electrode voltages Ue1, Ue2 and use it for the evaluation, as shown in FIG. 2b. Both measuring electrode voltages Ue1, Ue2 can also be captured and, for example, their average value can be used to determine the conductivity sigma of the medium 4. A conductivity sigma of the medium 4 can also be determined independently of each other with both of the measuring electrode voltages Ue1, Ue2 and the mean conductivity value can be used as the determined conductivity sigma of the medium 4.

In the examples, the first current circuit electrode 8a of the current source 9 is connected to a feed potential Uin and the second current circuit electrode 8b is connected to a reference potential, wherein the reference potential is the electrical reference potential to which the measuring electrode voltages Ue1, Ue2 are also measured. In the examples, the reference potential is also the electrical ground of the flowmeter 2.

In the examples shown in FIGS. 2, 4 and 5, the current source 9 generates an alternating current Im˜ with constant amplitude as the measuring current Im, wherein the quantity of interest of the measuring electrode voltage Ue1, Ue2 in conductivity measurement mode is the amplitude of the measuring electrode voltage Ue1, Ue2. Working with a measuring current Im˜ of alternating polarity is advantageous for similar reasons, which is why working with induced voltages with alternating polarity in the medium is also advantageous; for example, undesirable electrochemical effects are suppressed, which can otherwise occur when using constant quantities.

During the conductivity measurement mode, the flow measurement mode is suspended, in particular the magnetic field generating device 5 is not energized, so that no magnetic field B is generated and therefore no interfering induction voltage can occur in the medium 4.

In order to be able to draw conclusions about the electrical conductivity sigma of the medium 4 from a captured measuring electrode voltage Ue1, Ue2 in conductivity measurement mode, a corresponding relationship between these variables must be known, for example sigma(Ue1), sigma(Ue2) or sigma(Ue1, Ue2). This relationship between the measuring electrode voltage Ue1, Ue2 captured in conductivity measurement mode and the electrical conductivity sigma of the medium 4 in the measuring tube 3 is carried out in the examples of the method 1 and the flowmeter 2 shown by calibrating the flowmeter 2 with several media 4 of different but known electrical conductivity sigma. However, calibration can also be carried out individually for a device type.

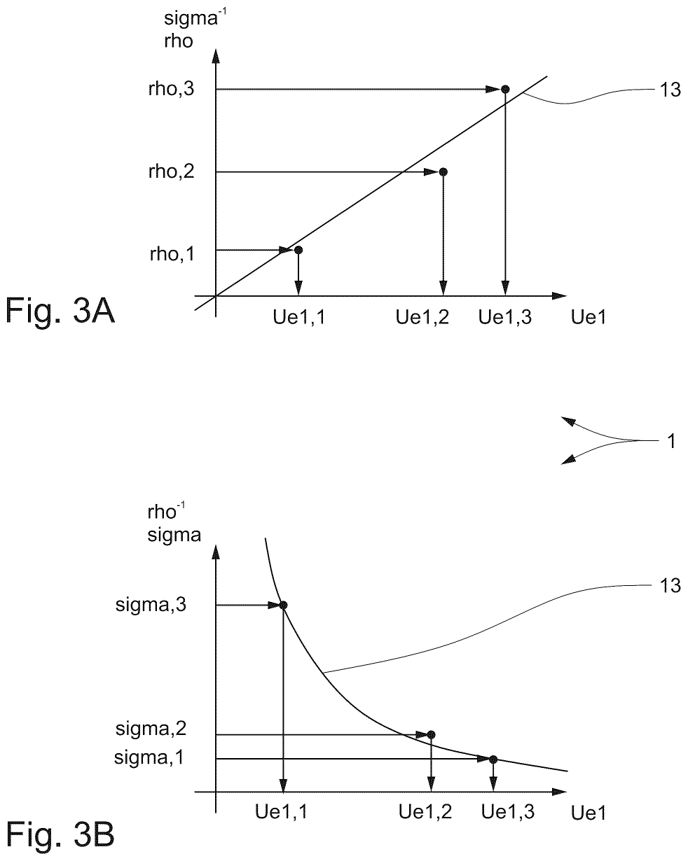

As shown in FIG. 3A, a linear relationship between the measuring electrode voltage Ue1 captured in conductivity measurement mode and the electrical conductivity sigma of the medium 4 in the measuring tube 3 is selected as a mathematical approximation of the relationship between the measuring electrode voltage Ue1 and the reciprocal value rho of the electrical conductivity sigma of the medium 4—i.e. the specific electrical resistance rho of the medium 4. For this purpose, several pairs of calibration values (rho,1; Ue1,1), (rho,2; Ue1,2), (rho,3; Ue1,3) of the measuring electrode voltage Ue1,1; Ue1,2; Ue1,3 and the associated reciprocal value rho,1; rho,2; rho,3 of the conductivity sigma of the medium 4 are determined and a compensation curve 13, in this case a compensation line, is laid through the pairs of calibration values. The compensation line in FIG. 3A shows a proportional relationship between the measuring electrode voltage Ue1 and the reciprocal value rho of the electrical conductivity sigma of the medium 4. The relationship is very easy to describe mathematically. It is also possible that the compensation line has a zero point offset, i.e. is not a zero point line, but the relationship is then linear and also easy to describe and calculate. In any case, the relationship is simpler than the roughly inversely proportional relationship shown in FIG. 3B and its mathematical formulation as a non-linear compensation curve 13.

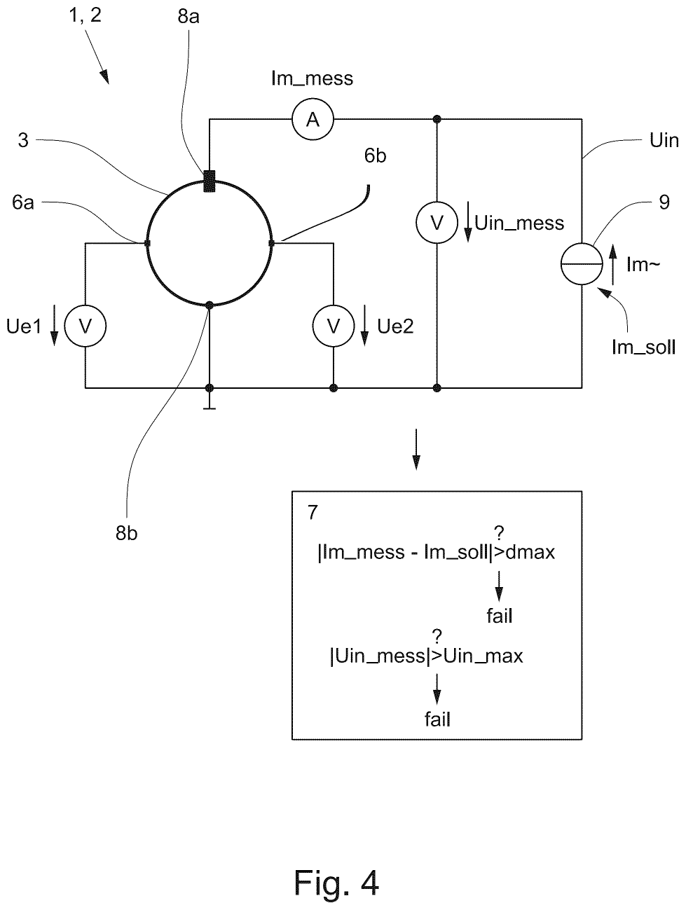

FIG. 4 shows that in conductivity measurement mode, the measurement current Im emitted by the current source 9—in this case an alternating current Im˜—is measured. The control and evaluation unit 7 is designed so that the conductivity measurement is recognized as faulty if the measured measuring current Im_mess deviates from a target measuring current Im_soll specified for the current source 9. In this case, the detected error status (fail) is made visible to the outside by signaling on a display. Since the current source 9 outputs an alternating current Im˜, the measured measuring current Im_mess is the amplitude of the alternating current and the setpoint Im_soll is also a specification for the amplitude of the alternating current Im.

Furthermore, the example according to FIG. 4 shows that in conductivity measurement mode, the feed voltage Uin is measured at the first current circuit electrode 8a. The supply voltage Uin is the supply potential Uin in relation to the reference potential, i.e. the ground potential of the circuit. In the event that the measured supply voltage Uin_mess is larger than a specified maximum value for the supply voltage Uin_max, the conductivity measurement is recognized as faulty and also displayed as faulty (fail).

For all examples shown (except FIG. 1), the control and evaluation unit 7 is designed in such a way that it performs the method 1 shown in the figures in conductivity measurement mode.

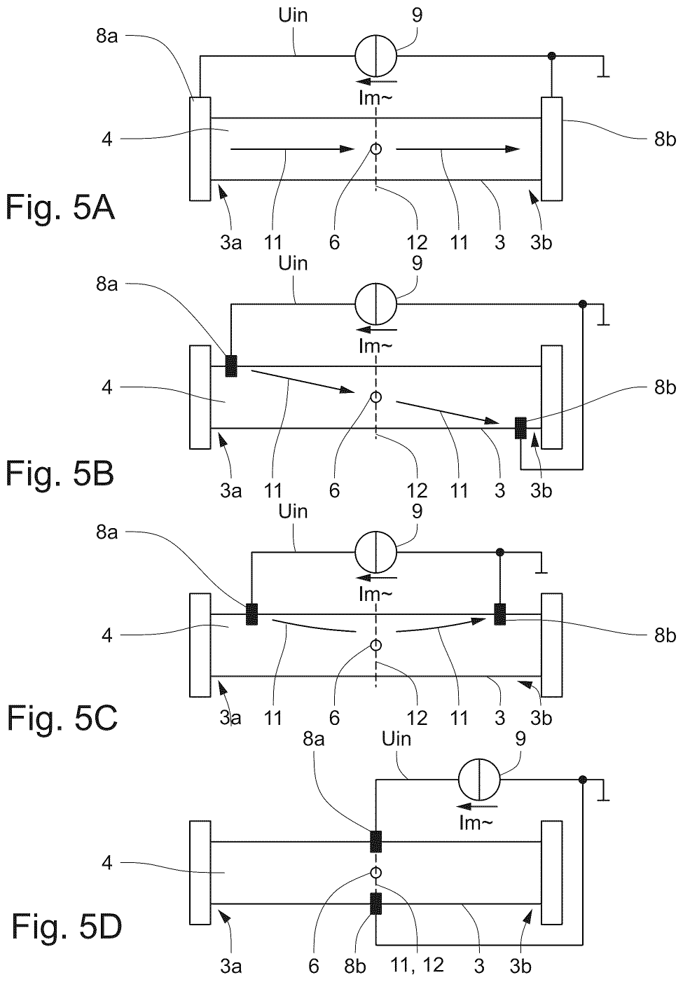

FIGS. 5A to 5D show different variations of the implementation of the circuit electrodes 8a, 8b in the area of the measuring tube 3. In principle, the circuit electrodes 8a, 8b must be inserted into the measuring tube 3 or designed in the measuring tube 3 in such a way that they are not short-circuited by the measuring tube 3, because the conductivity circuit 10 must be closed via the medium 4, there via the medium current path 11 in the medium 4, in order for the conductivity measurement to work.

FIG. 2 already shows a magnetic-inductive flowmeter 2 in which one of the circuit electrodes 8b is designed as a conductive flange at the end of the measuring tube 3. In the magnetic-inductive flowmeter 2 according to FIG. 5A, both circuit electrodes 8a, 8b are designed as a conductive flange at the end of the measuring tube 3, the first circuit electrode 8a is arranged as one flange in the inflow region 3a and the second circuit electrode 8b is arranged as the other flange in the outflow region 3b of the measuring tube 3. Here, the flanges are electrically insulated on the outside, but not on the inside, so that electrical contact with the medium 4 is ensured.

In the magnetic-inductive flowmeters 2 according to FIGS. 2A, 5B and 5D, at least one of the circuit electrodes 8a in the area of the measuring tube 3 is arranged axially offset to a measuring electrode plane 12 in which the measuring electrodes 6a, 6b are arranged and which measuring electrode plane 12 runs perpendicular to the axial extension of the measuring tube 4, the measuring electrodes 6a, 6b are also located between the inflow region 3a and the outflow region 3b. In the examples shown in FIGS. 5B and 5C, this even applies to both of the circuit electrodes 8a, 8b. The positioning of the circuit electrodes 8a, 8b shown in these examples is associated with additional design effort, as the circuit electrodes 8a, 8b must be electrically insulated in the wall of the measuring tube 3 and must also meet the mechanical strength requirements and the fluid sealing requirements. However, this also offers the possibility of accommodating the circuit electrodes 8a, 8b in a particularly protected manner, both against contact from the outside (as the measuring tube 3 is usually surrounded by a housing) and against contact from inside the measuring tube, for example by abrasive media, as the circuit electrodes 8a. 8b can be mounted flush with the measuring tube wall or even recessed.

In the magnetic-inductive flowmeter 2 shown in FIG. 5D, the circuit electrodes 8a, 8b are arranged in the measuring electrode plane 12. The connecting line between the circuit electrodes 8a, 8b is perpendicular to the connecting line between the measuring electrodes 6a, 6b, so that the medium flow path, via which the supply voltage Uin drops, passes directly through the measuring electrodes 6a, 6b. Since the measuring electrodes 6a, 6b are arranged centrally between the inflow region 3a and the outflow region 3b of the measuring tube 3, the current circuit electrodes 8a, 8b are also centrally located between the inflow region 3a and the outflow region 3b of the measuring tube 3.

The measuring electrodes 6a, 6b and the circuit electrodes 8a, 8b lie on a circumferential line of the measuring tube 3, which has certain manufacturing advantages. Interestingly, however, with the designs in which the current circuit electrodes 8a, 8b are arranged axially, i.e. offset in the direction of flow of the medium relative to the measuring electrodes 6a, 6b and thus also the measuring electrode plane 12, so that the medium flow path 11 also has an axial extension component in the measuring tube 3, better results can be achieved with regard to determining the electrical conductivity sigma of the medium 4, which applies throughout to the other examples, i.e. to the magnetic-inductive flowmeters 2 according to FIGS. 2 and 5A to 5C.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for operating a magnetic-inductive flowmeter, which comprises at least one measuring tube with an inflow region, an outflow region, and a measuring region located between the inflow region and the outflow region to conduct a flowing medium through the flowmeter, the method comprising:
generating, via at least one magnetic field generating device, a magnetic field passing through the measuring tube in the measuring region substantially perpendicular to a direction of a flow of the medium;
providing at least one pair of measuring electrodes in the measuring region of the measuring tube to tap an electrical voltage induced in the medium in the measuring tube;
providing at least one control and evaluation unit which, in a flow measurement mode, determines a flow measurement value from the measured induced electrical voltage;
arranging a first current circuit electrode and a second current circuit electrode in a region of the measuring tube to be in contact with the medium, at least when the measuring tube is completely filled or filled to a predetermined level with medium;
connecting the first and second current circuit electrodes to a current source outside the measuring tube;
subjecting the first and second current circuit electrodes to a measuring current in a conductivity measuring mode, the first and second current circuit electrodes being arranged such that a conductivity circuit closes via a medium current path in the medium at least when the measuring tube is completely filled with medium, the medium current path passing through the flow cross-section of the measuring tube in which the measuring electrodes are located, so that an electrical voltage drop results between the circuit electrodes in the medium;
capturing at least one measuring electrode voltage with at least one of the measuring electrodes in a conductivity measurement mode; and
determining, via the control and evaluation unit, an electrical conductivity of the medium in the measuring tube from the captured measuring electrode voltage.

2. The method according to claim 1, wherein the first current circuit electrode is connected by the current source to a supply potential, and wherein the second current circuit electrode is connected to a reference potential, or wherein the reference potential is the electrical reference potential to which the measuring electrode voltages are also measured.

3. The method according to claim 1, wherein the current source generates an alternating current with a constant amplitude or a direct current with a constant level as the measuring current, or wherein the quantity of interest of the measuring electrode voltage in a conductivity measurement mode is an amplitude of the measuring electrode voltage or a level of the measuring electrode voltage.

4. The method according to claim 1, wherein the flow measurement mode is suspended during the conductivity measurement mode, or wherein the magnetic field generating device is not energized, so that no magnetic field is generated.

5. The method according to claim 1, wherein a relationship between the measuring electrode voltage captured in a conductivity measurement mode and the electrical conductivity of the medium in the measuring tube is established by calibrating the flowmeter with a plurality of media of different electrical conductivity.

6. The method according to claim 5, wherein a linear relationship between the measuring electrode voltage captured in the conductivity measuring mode and the electrical conductivity of the medium in the measuring tube is selected as a mathematical approximation of the relationship between the measuring electrode voltage and the reciprocal value of the electrical conductivity of the medium, or wherein a compensation curve or a compensation line is laid by several pairs of calibration values of the measuring electrode voltage and an associated reciprocal value of the conductivity of the medium, and wherein the compensation curve is used to determine the electrical conductivity of the medium as a function of the captured measuring electrode voltage in the conductivity measurement mode.

7. The method according to claim 1, wherein, in the conductivity measurement mode, the measurement current emitted by the current source is measured and, if the measured measurement current deviates from a target measurement current specified for the current source, the conductivity measurement is detected as faulty, or wherein the detected error status is signaled to the outside or is displayed on a display or is transmitted as an error message via a signal interface to the outside of the flowmeter.

8. The method according to claim 1, wherein, in the conductivity measurement mode, the feed voltage at the first circuit electrode is measured and, in an event that the measured feed voltage is larger than a predetermined maximum value for the feed voltage, the conductivity measurement is detected as faulty, or wherein the detected error status is signaled to the outside or shown on a display or transmitted as an error message via a signal interface to the outside of the flowmeter.

9. The method according to claim 1, wherein the measuring current is provided with a characteristic time characteristic and it is checked whether the captured measuring electrode voltage has a corresponding characteristic time characteristic in the conductivity measurement mode, wherein the conductivity measurement is detected as faulty if the time characteristics of the measuring current and measuring electrode voltage deviate, or wherein the detected error status is signaled to the outside or is shown on a display or is transmitted as an error message via a signal interface to the outside of the flowmeter.

10. The method according to claim 1, wherein, in the conductivity measurement mode, two measuring electrode voltages are captured with the two measuring electrodes and the two measuring electrode voltages are compared with one another, wherein if there is a deviation between the two measuring electrode voltages exceeding a deviation threshold, the conductivity measurement is recognized as faulty, or wherein the detected error status is signaled to the outside or shown on a display or transmitted as an error message via a signal interface to the outside of the flowmeter.

11. A magnetic-inductive flowmeter comprising:
at least one measuring tube with an inflow region, an outflow region, and a measuring region located between the inflow region and the outflow region to conduct a flowing medium through the flowmeter;
at least one magnetic field generating device to generate a magnetic field passing through the measuring tube in the measuring region substantially perpendicular to the direction of flow of the medium;
at least one pair of measuring electrodes arranged in the measuring region of the measuring tube to tap an electrical voltage induced in the medium in the measuring tube; and
at least one control and evaluation unit that determines a flow measurement value from the measured induced electrical voltage in a flow measurement mode; and
a first current circuit electrode and a second current circuit electrode arranged in a region of the measuring tube to be in contact with the medium, at least when the measuring tube is completely filled or filled to a predetermined level with medium, the first and second current circuit electrodes being connected to a current source outside the measuring tube, the current source, in a conductivity measurement mode, supplying the first and second current circuit electrodes with a measuring current, the first and second current circuit electrodes being arranged such that a conductivity circuit closes in the medium via a medium flow path at least when the measuring tube is completely filled or filled to a predetermined level with medium, the medium flow path passing the flow cross-section of the measuring tube in which the at least one pair of measuring electrodes are located,
wherein the control and evaluation unit is designed such that it performs the method according to claim 1 in a conductivity measurement mode.

12. The magnetic-inductive flowmeter according to claim 11, wherein at least one of the first or second circuit electrodes is designed as a conductive flange at an end of the measuring tube.

13. The magnetic-inductive flowmeter according to claim 12, wherein both the first and second current circuit electrodes are designed as a conductive flange at the end of the measuring tube, wherein the first current circuit electrode is arranged as one flange in the inflow region, and wherein the second current circuit electrode is arranged as the other flange in the outflow region of the measuring tube.

14. The magnetic-inductive flowmeter according to claim 12, wherein one of the first or second circuit electrodes is designed both as a conductive flange in the inflow region and as a conductive flange in the outflow region of the measuring tube.

15. The magnetic-inductive flowmeter according to claim 11, wherein at least one of the circuit electrodes is arranged in the region of the measuring tube axially offset from a measuring electrode plane in which the measuring electrodes are arranged and which extends substantially perpendicularly to an axial extension of the measuring tube between the inflow region and the outflow region, or wherein both of the current circuit electrodes are arranged in the region of the measuring tube axially offset to the measuring electrode plane and between the inflow region and the outflow region.

16. The magnetic-inductive flowmeter according to claim 11, wherein one of the first or second current circuit electrodes is arranged in the measuring electrode plane, or wherein both the first and second current circuit electrodes are arranged in the measuring electrode plane.
